(19) United States
(12) Patent Application Publication
(10) Pub. No.: US 2019/0265728 A1
(43) Pub. Date: Aug. 29, 2019

(54) VEHICLE CONTROL DEVICE

(71) Applicant: HONDA MOTOR CO., LTD., Tokyo (JP)

(72) Inventors: Marina SAIKYO, WAKO-SHI (JP); Hiroshi MIURA, WAKO-SHI (JP); Toshifumi SUZUKI, WAKO-SHI (JP); Suguru YANAGIHARA, WAKO-SHI (JP)

(21) Appl. No.: 16/284,450

(22) Filed: Feb. 25, 2019

(30) Foreign Application Priority Data
Feb. 26, 2018 (JP) 2018-031550

(51) Int. Cl. G05D 1/02; G05D 1/00

(52) U.S. Cl. CPC G05D 1/0293; G05D 1/0231; G05D 1/0088

(57) ABSTRACT

An external environment recognition unit identifies a hearse or a funeral attendant vehicle following the hearse, from among at least one other vehicle traveling in a same forward traveling direction as a host vehicle in front of or on a side of the host vehicle. In the case that the external environment recognition unit identifies the hearse or the funeral attendant vehicle, the action planning unit plans an action of positioning the host vehicle at a location more rearwardly than a vehicle at a trailing end (trailing end vehicle) from among the hearse and the funeral attendant vehicle.

### CROSS-REFERENCE TO RELATED APPLICATION

This application is based upon and claims the benefit of priority from Japanese Patent Application No. 2018-031550 filed on Feb. 26, 2018, the contents of which are incorporated herein by reference.

### BACKGROUND OF THE INVENTION

### Field of the Invention

The present invention relates to a vehicle control device adapted to carry out a travel control for a host vehicle in the case that a specialized type of vehicle is encountered.

### Description of the Related Art

In Japanese Laid-Open Patent Publication No. 2014-154128, it is disclosed that, in the case that an emergency vehicle (an ambulance, a fire engine, a police car, etc.) comes into proximity to a general vehicle traveling under an automated driving control, the general vehicle is made to move over and stop so that the emergency vehicle is allowed to travel in a preferential manner.

### SUMMARY OF THE INVENTION

Certain regions also exist in which roads are provided which allow specialized vehicles other than emergency vehicles, for example, hearses, to travel thereon in a preferential manner. In such regions, in the case that a hearse is encountered, the driver performs a travel control for the host vehicle (driver's own vehicle) in a customary way. However, with automatically driven vehicles and driving assist vehicles, which in recent years are expected to become popular and spread, consideration has not been given to controlling the host vehicle from the standpoint of allowing a hearse to travel smoothly.

The present invention has been devised taking into consideration the aforementioned problem, and has the object of providing a vehicle control device which is capable of allowing a hearse to travel smoothly by executing a travel control in a host vehicle.

A vehicle control device according to the present invention comprises an external environment recognition unit configured to recognize an environment around a periphery of a host vehicle, an action planning unit configured to plan an action of the host vehicle on a basis of a recognition result of the external environment recognition unit, and a vehicle control unit configured to cause the host vehicle to travel in accordance with the action planned by the action planning unit, wherein the external environment recognition unit is configured to identify a hearse or a funeral attendant vehicle following the hearse, from among at least one other vehicle traveling in a same forward traveling direction as the host vehicle in front of or on a side of the host vehicle, and in a case that the external environment recognition unit identifies the hearse or the funeral attendant vehicle, the action planning unit is configured to plan an action of positioning the host vehicle at a location more rearwardly than a vehicle at a trailing end from among the hearse and the funeral attendant vehicle.

In accordance with the above-described configuration, by positioning the host vehicle rearwardly of the trailing end vehicle from among the hearse or the funeral attendant vehicle, the hearse and the funeral attendant vehicle are allowed to travel in a more preferential manner than the host vehicle, and therefore, it is possible to enable the hearse and the funeral attendant vehicle to travel smoothly. Further, the host vehicle can be made to move in a customary way.

In the present invention, the action planning unit may be configured to plan an action to cause the host vehicle to decelerate when a vehicle velocity of the host vehicle is higher than the vehicle velocity of the hearse and the funeral attendant vehicle.

In accordance with the above-described configuration, the host vehicle does not pass or overtake the hearse or the funeral attendant vehicle, and therefore, the hearse can be allowed to travel smoothly.

In the present invention, at a rearward position of the hearse or the funeral attendant vehicle, the action planning unit may be configured to plan an action to maintain a constant distance between the host vehicle and the vehicle at the trailing end from among the hearse and the funeral attendant vehicle.

In accordance with the above-described configuration, the host vehicle does not pass or overtake the hearse or the funeral attendant vehicle, and therefore, the hearse can be allowed to travel smoothly.

In the present invention, the action planning unit may be configured to plan an action to cause the host vehicle to move to an edge of the travel path and come to a stop, when a vehicle velocity of the host vehicle is higher than the vehicle velocity of the hearse and the funeral attendant vehicle.

In accordance with the above-described configuration, the host vehicle does not pass or overtake the hearse or the funeral attendant vehicle, and therefore, the hearse can be allowed to travel smoothly.

In the present invention, there may further be provided at least one of a camera configured to capture an image of the periphery of the host vehicle and acquire image information, and a communication device configured to receive external environmental information transmitted from the external environment, wherein the external environment recognition unit is configured to recognize the other vehicle based on the image information or the external environmental information.

In accordance with the above-described configuration, it is possible to recognize the hearse using the image captured by the camera or information transmitted from another vehicle.

In the present invention, in a case that the external environment recognition unit recognizes a characteristic of an external appearance of the hearse on the other vehicle, the external environment recognition unit may be configured to identify the other vehicle that possesses the characteristic as the hearse.

In accordance with the above-described configuration, it is possible to recognize a hearse from a characteristic feature of the hearse, for example, from an appearance and shape, a color, a decoration, a marking, a lighting state of a hazard light, a flag, etc., of the hearse.

In the present invention, in a case that the external environment recognition unit identifies a police vehicle from among the other vehicle, and recognizes another vehicle following the police vehicle, the external environment recognition unit may be configured to identify the other vehicle as the hearse.

In accordance with the above-described configuration, it is possible to recognize the hearse from a travel state that is peculiar to a hearse, in this instance, a motorcade with a police vehicle at a leading end thereof.

In the present invention, in a case that the external environment recognition unit recognizes a group of people lined up along a roadside, and the other vehicle exists for which there is a possibility of it being the hearse, the external environment recognition unit may be configured to identify the other vehicle as the hearse.

In accordance with the above-described configuration, it is possible to recognize the existence of the hearse from a surrounding environment that is peculiar to a time of traveling of a hearse, in this instance, the existence of a group of people lined up along a roadside.

In the present invention, there may further be provided a positioning unit configured to measure a position of the host vehicle, wherein the external environment recognition unit is configured to acquire information as to whether or not a cemetery exists within a predetermined distance from the position of the host vehicle based on the external environmental information or map information, and in a case that the cemetery exists, and the other vehicle exists for which there is a possibility of it being the hearse, the external environment recognition unit may be configured to identify the other vehicle as the hearse.

In accordance with the above-described configuration, it is possible to recognize the existence of the hearse from a surrounding environment that is peculiar to a time of traveling of a hearse, in this instance, the existence of a cemetery.

In the present invention, in a case that the external environment recognition unit recognizes a characteristic of an external appearance of the funeral attendant vehicle on the other vehicle, the external environment recognition unit may be configured to identify the other vehicle that possesses the characteristic as the funeral attendant vehicle.

In accordance with the above-described configuration, it is possible to recognize the funeral attendant vehicle based on a characteristic feature of the funeral attendant vehicle, for example, a marking, a lighting state of a hazard light, and the like.

In the present invention, there may further be provided a notification control unit configured to control notification to a vehicle occupant according to a notification action planned by the action planning unit, wherein, in a case that the external environment recognition unit is incapable of identifying whether or not the other vehicle is the hearse, the action planning unit may be configured to plan the notification action to prompt the vehicle occupant to select a vehicle control.

In accordance with the above-described configuration, since the driver selects the control in the event it is impossible to recognize on the side of the vehicle whether or not the other vehicle is a hearse, in a case that the other vehicle is a hearse, the driver can appropriately determine the control, and as a result, it is possible to enable the hearse to travel smoothly.

In the present invention, there may further be provided a notification control unit configured to control notification to a vehicle occupant according to a notification action planned by the action planning unit, wherein, in a case that the external environment recognition unit is incapable of identifying whether or not the other vehicle is the funeral attendant vehicle, the action planning unit may be configured to plan the notification action to prompt the vehicle occupant to select a vehicle control.

In accordance with the above-described configuration, since the driver selects the control in the event it is impossible to recognize on the side of the vehicle whether or not the other vehicle is a funeral attendant vehicle, in a case that the other vehicle is a funeral attendant vehicle, the driver can appropriately determine the control, and as a result, it is possible to enable the funeral attendant vehicle to travel smoothly.

In the present invention, after the host vehicle has stopped, the external environment recognition unit may be configured to recognize whether or not the hearse or the funeral attendant vehicle exists within a predetermined range in front of the host vehicle, and in a case that the external environment recognition unit recognizes that the hearse and the funeral attendant vehicle do not exist within the predetermined range, the action planning unit may be configured to plan an action to restart traveling of the host vehicle.

In accordance with the above-described configuration, it is possible to quickly restart normal traveling of the host vehicle.

In the present invention, there may further be provided a restart switch configured to output a travel restart signal in response to an operation of the vehicle occupant, wherein after the host vehicle has stopped, the external environment recognition unit may be configured to recognize whether or not the hearse or the funeral attendant vehicle exists within a predetermined range in front of the host vehicle, and in a case that the external environment recognition unit recognizes that the hearse and the funeral attendant vehicle do not exist within the predetermined range, and detects the travel restart signal, the action planning unit may be configured to plan an action to restart traveling of the host vehicle.

In accordance with the above-described configuration, it is possible to restart normal traveling of the host vehicle at a desired timing.

In the present invention, there may further be provided a notification control unit configured to control notification to a vehicle occupant according to a notification action planned by the action planning unit, wherein, in a case that the external environment recognition unit identifies the hearse and the funeral attendant vehicle, the action planning unit may be configured to plan the notification action to notify the vehicle occupant that the hearse and the funeral attendant vehicle are traveling.

In accordance with the above-described configuration, it is possible to cause the vehicle occupant to recognize the existence of the hearse, and further, it is possible to grasp the cause of a behavior of the host vehicle (movement, deceleration, etc., of the host vehicle).

In the present invention, there may further be provided a positioning unit configured to measure a position of the host vehicle, and a route setting unit configured to set a planned route from a position of the host vehicle to a destination on a basis of map information, wherein, in a case that the action planning unit plans an action to cause the host vehicle to travel along the planned route, and the external environment recognition unit identifies the hearse and the funeral attendant vehicle, the action planning unit may be configured to instruct the route setting unit to reset the planned route, and according to the instruction from the action planning unit, the route setting unit may be configured to reset a new planned route to avoid a road on which the hearse and the funeral attendant vehicle travel.

In accordance with the above-described configuration, it is possible to avoid encountering the hearse again after the host vehicle has restarted normal traveling.

According to the present invention, since the hearse and the funeral attendant vehicle are allowed to travel in a more preferential manner than the host vehicle, it is possible to enable the hearse and the funeral attendant vehicle to travel smoothly.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram of a host vehicle equipped with a vehicle control device according to the present embodiment;

FIG. 2 is a functional block diagram of a computation device;

FIG. 3 is a flowchart of processing steps performed by the vehicle control device according to the present embodiment;

FIG. 4 is a diagram for explaining a vehicle control in the case that the host vehicle approaches a hearse and the like from behind; and

FIG. 5 is a diagram for explaining a vehicle control in the case that the host vehicle travels alongside a hearse and the like.

### DESCRIPTION OF THE PREFERRED EMBODIMENTS

A preferred embodiment of a vehicle control device according to the present invention will be described in detail below with reference to the accompanying drawings.

### [1. Configuration of Host Vehicle 10]

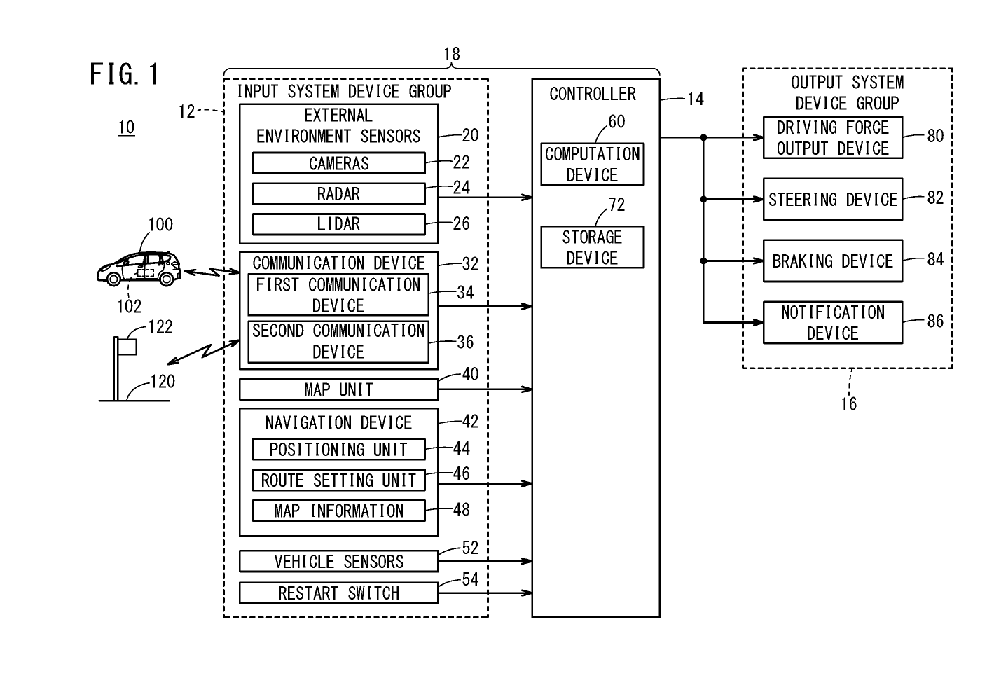

As shown in FIG. 1, a host vehicle 10 is equipped with an input system device group 12 which acquires or stores various information, a controller 14 to which information that is output from the input system device group 12 is input, and an output system device group 16 which is operated in response to various instructions output from the controller 14. A vehicle control device 18 according to the present embodiment includes the input system device group 12 and the controller 14. The host vehicle 10 is an automatically driven vehicle (including a fully automatically driven vehicle) in which a travel control is performed by the controller 14, or a driving assisted vehicle in which portions of the travel control are assisted.

### [1.1. Input System Device Group 12]

In the input system device group 12, there are included external environment sensors 20, a communication device 32, a map unit 40, a navigation device 42, vehicle sensors 52, and a restart switch 54. The external environment sensors 20 detect the state of the surrounding periphery (external environment) of the host vehicle 10. Among the external environment sensors 20, there are included a plurality of cameras 22 that capture images of the external environment, a plurality of radar devices 24 and one or more LIDAR devices 26 that detect the distance between the host vehicle 10 and other surrounding objects, as well as the relative velocity between the host vehicle 10 and the surrounding objects. The communication device 32 transmits and receives information. In the communication device 32, there are included a first communication device 34 and a second communication device 36. The first communication device 34 performs inter-vehicle communications with communication devices 102 provided in other vehicles 100, and acquires external environmental information including information (a type of car, a travel state, a traveling position, etc.) of the other vehicles 100. The second communication device 36 performs road-to-vehicle communications with communication devices 122 provided in infrastructure of a host vehicle travel path 120, and acquires external environmental information including road information (information in relation to traffic signals, traffic congestion information, and the like). The map unit 40 stores high precision map information including information such as the number of lanes, the lane type, the lane width, and the like. The navigation device 42 comprises a positioning unit 44 that measures the position of the host vehicle 10 by way of satellite navigation or autonomous navigation, map information 48, and a route setting unit 46 which sets a planned route from the position of the host vehicle 10 to a destination on the basis of the map information 48. The vehicle sensors 52 detect the travel state of the host vehicle 10. The vehicle sensors 52 include a vehicle velocity sensor, an acceleration sensor, a yaw rate sensor, an inclination sensor, and the like, none of which are shown. The restart switch 54 is provided in a passenger compartment, and outputs a travel restart signal in accordance with an operation made by the vehicle occupant.

### [1.2. Output System Device Group 16]

In the output system device group 16, there are included a driving force output device 80, a steering device 82, a braking device 84, and a notification device 86. The driving force output device 80 includes a driving force output ECU and a drive source such as an engine or a traction motor. The driving force output device 80 generates a driving force in accordance with an operation of an accelerator pedal performed by the vehicle occupant, or a driving control instruction output from the controller 14. The steering device 82 includes an electric power steering system (EPS) ECU and an EPS actuator. The steering device 82 generates a steering force in accordance with an operation of the steering wheel performed by the vehicle occupant, or a steering control instruction output from the controller 14. The braking device 84 includes a brake ECU and a brake actuator. The braking device 84 generates a braking force in accordance with an operation of the brake pedal performed by the vehicle occupant, or a braking control instruction output from the controller 14. The notification device 86 includes a notification ECU, and an information transmission device (a display device, an audio device, a haptic device, etc.). The notification device 86 issues a notification with respect to the vehicle occupant in accordance with a notification instruction output from the controller 14 or another ECU.

### [1.3. Controller 14]

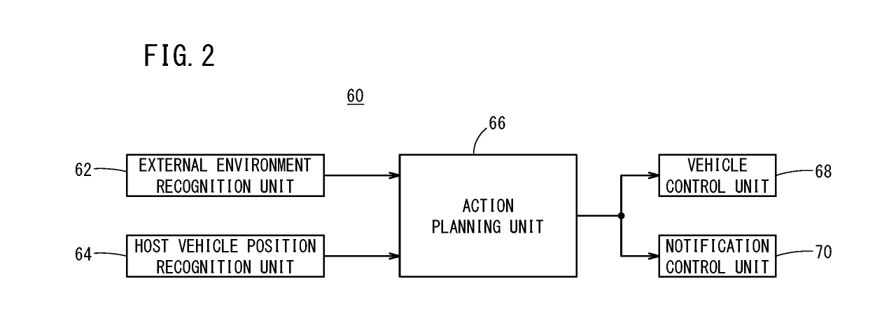

The controller 14 comprises an ECU, and includes a computation device 60 such as a processor, and a storage device 72 such as a ROM and a RAM. The controller 14 realizes various functions by the computation device 60 executing programs stored in the storage device 72. As shown in FIG. 2, the computation device 60 functions as an external environment recognition unit 62, a host vehicle position recognition unit 64, an action planning unit 66, a vehicle control unit 68, and a notification control unit 70.

On the basis of information output from the external environment sensors 20, the communication device 32, the map unit 40, and the navigation device 42, the external environment recognition unit 62 recognizes the periphery around the host vehicle 10. For example, based on the image information acquired by the cameras 22, the information acquired by the radar devices 24 and the LIDAR devices 26, and the external environmental information acquired by the first communication device 34, the external environment recognition unit 62 recognizes the existence, the position, the size, the type, and the forward traveling direction of other vehicles 100 which are traveling or stopped in the vicinity of the host vehicle 10, together with recognizing the distance and the relative velocity between the host vehicle 10 and the other vehicles 100. Further, on the basis of the image information acquired by the cameras 22, the information acquired by the radar devices 24 and the LIDAR devices 26, the high precision map stored in the map unit 40, the map information 48 stored in the navigation device 42, and the external environmental information acquired by the second communication device 36, the external environment recognition unit 62 recognizes the shapes and positions of objects to be recognized that are included in the road environment (roads, lane markings, facilities around the periphery of the road, spaces). Further, on the basis of the image information acquired by the cameras 22 or the external environmental information acquired by the second communication device 36, the external environment recognition unit 62 recognizes the signals (a forward traveling permissible state, a forward traveling prohibited state) that are indicated by the traffic signals.

Based on information output from the map unit 40 and the navigation device 42, the host vehicle position recognition unit 64 recognizes the position of the host vehicle 10.

The action planning unit 66 plans an optimal action for the host vehicle 10, on the basis of recognition results from the external environment recognition unit 62 and the host vehicle position recognition unit 64, and detection information from the vehicle sensors 52. For example, the action planning unit 66 plans behaviors of the host vehicle 10 at each of respective points in time, and generates target travel trajectories and target velocities in order to realize such behaviors. Further, in the case that a planned route is set, the action planning unit 66 plans actions that cause the host vehicle 10 to reach a destination along the planned route, and in the case that a planned route is not set, the action planning unit 66 plans actions that cause the host vehicle 10 to travel along the road. Further, the action planning unit 66 plans actions apart from the travel control, for example, the content and timing of notification actions or the like to be issued with respect to the vehicle occupant.

The vehicle control unit 68 controls the output system device group 16 on the basis of the actions planned by the action planning unit 66. For example, the vehicle control unit 68 calculates steering command values corresponding to the target travel trajectory generated by the action planning unit 66, and acceleration/deceleration command values in accordance with the target vehicle velocity, and outputs control instructions with respect to the driving force output device 80, the steering device 82, and the braking device 84.

The notification control unit 70 outputs notification instructions to the notification device 86 based on the notification actions planned by the action planning unit 66.

Apart from the various programs executed by the computation device 60, the storage device 72 shown in FIG. 1 stores numerical values used for comparisons and determinations made in the respective processes.

### [2. Operations of the Vehicle Control Device 18]

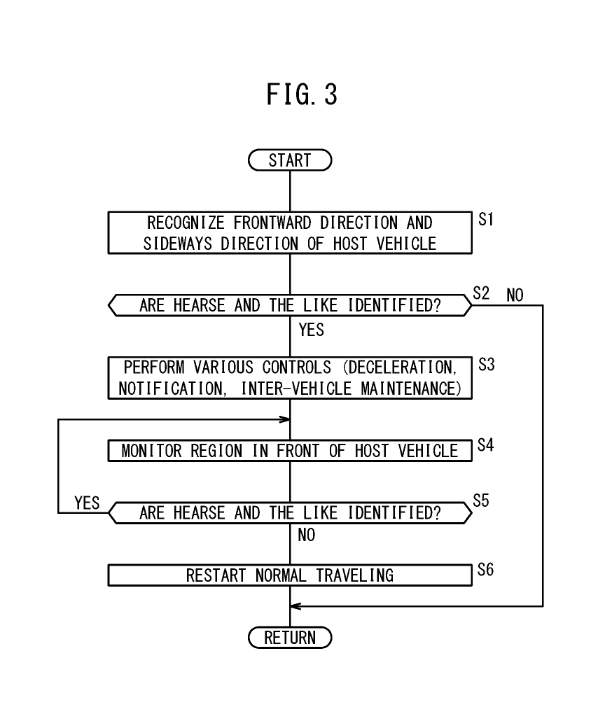

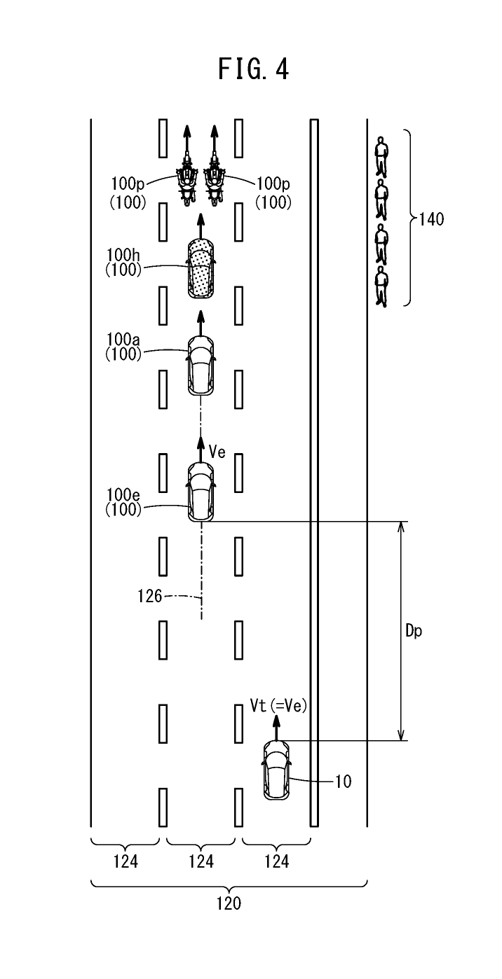

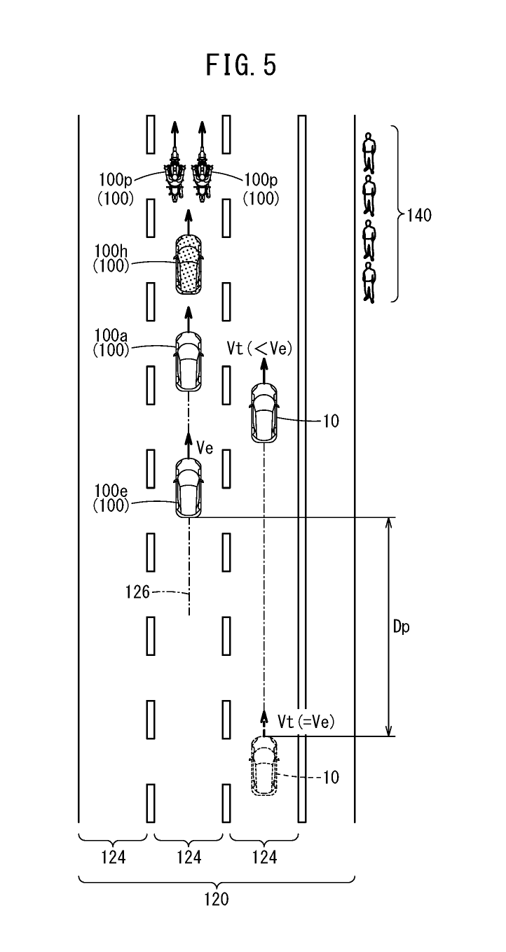

Operations of the vehicle control device 18 will now be described with reference to FIG. 3. In this instance, the situations shown in FIG. 4 and FIG. 5 are assumed. More specifically, as shown in FIG. 4, a situation is assumed in which the host vehicle 10 approaches from behind a hearse 100h or at least one funeral attendant vehicle 100a following the hearse 100h, and as shown in FIG. 5, a situation is assumed in which the host vehicle 10 travels alongside the hearse 100h or the funeral attendant vehicle 100a. Hereinafter, the hearse 100h and the funeral attendant vehicle 100a may also be collectively referred to as a hearse 100h and the like. FIGS. 4 and 5 illustrate situations in which vehicles travel on a right side of the road. The process to be described below is repeatedly executed while the electric power of the host vehicle 10 is turned on.

In step S1, the external environment recognition unit 62 recognizes a frontward direction and a sideways direction of the host vehicle 10 on the basis of the latest information output from the input system device group 12. In addition, the external environment recognition unit 62 identifies the hearse 100h and the like from among the other vehicles 100 traveling in the same forward traveling direction as the host vehicle 10, that is, from among the other vehicles 100 traveling on the host vehicle travel path 120. The identification method for identifying the hearse 100h and the like will be described below in item [3].

In the case that the external environment recognition unit 62 identifies the hearse 100h and the like (step S2: YES), the process proceeds to step S3. On the other hand, in the case that the external environment recognition unit 62 does not identify the hearse 100h and the like (step S2: NO), the series of process steps is brought to an end, and the vehicle control device 18 waits until a subsequent process start timing.

Transitioning from step S2 to step S3, the vehicle control device 18 performs various controls. In this instance, the external environment recognition unit 62 identifies as a trailing end vehicle 100e the hearse 100h or the like that is traveling at the trailing end from among the hearse 100h and the like that are capable of being recognized. The action planning unit 66 plans an action of positioning the host vehicle 10 at a location behind or more rearwardly than the trailing end vehicle 100e.

For example, on the basis of the detection information of the radar devices 24 or the LIDAR devices 26, the external environment recognition unit 62 recognizes the relative velocity of the hearse 100h and the like with respect to the host vehicle 10, as well as the vehicle velocity Ve of the trailing end vehicle 100e. In the case that the relative velocity is negative, the vehicle velocity V of the host vehicle 10 is faster than the vehicle velocity Ve of the hearse 100h and the like, and the host vehicle 10 is about to pass or overtake the hearse 100h and the like. At this time, a vehicle control for the host vehicle 10 is carried out.

As shown in FIG. 4, when the host vehicle 10 comes into proximity to the hearse 100h and the like from behind, the host vehicle 10 is already located more rearwardly than the trailing end vehicle 100e. At this time, the action planning unit 66 plans an action in a manner so that the host vehicle 10 will not catch up with the trailing end vehicle 100e. In this instance, the action planning unit 66 plans an inter-vehicle distance maintenance behavior, so as to decelerate the host vehicle 10 to a vehicle velocity below the current vehicle velocity V, and to maintain the distance D between the host vehicle 10 and the trailing end vehicle 100e at a predetermined distance Dp. More specifically, the action planning unit 66 sets a target vehicle velocity Vt in order to set the distance D recognized by the external environment recognition unit 62 to the predetermined distance Dp. As a result, the target vehicle velocity Vt becomes substantially equivalent to the vehicle velocity Ve of the trailing end vehicle 100e. The vehicle control unit 68 calculates a steering amount and a degree of acceleration/deceleration of the host vehicle 10 on the basis of the action planned by the action planning unit 66, outputs a steering instruction to the steering device 82, outputs an acceleration instruction to the driving force output device 80, and outputs a deceleration instruction to the braking device 84.

As shown in FIG. 5, in the case that the host vehicle 10 travels alongside the hearse 100h and the like, the host vehicle 10 is positioned ahead or in front of the trailing end vehicle 100e. At this time, the action planning unit 66 plans an action in a manner so that the host vehicle 10 is overtaken by the trailing end vehicle 100e. In this instance, the action planning unit 66 plans an action of decelerating the host vehicle 10 to a vehicle velocity below the current vehicle velocity V and positioning the host vehicle 10 at a location behind or rearwardly of the trailing end vehicle 100e. More specifically, the action planning unit 66 sets a target vehicle velocity Vt (<Ve) to be less than the vehicle velocity Ve of the sideways located hearse 100h and the like or the trailing end vehicle 100e. The vehicle control unit 68 calculates a steering amount and a degree of deceleration of the host vehicle 10 on the basis of the action planned by the action planning unit 66, outputs a steering instruction to the steering device 82, and outputs a deceleration instruction to the braking device 84. When the distance D between the host vehicle 10 and the trailing end vehicle 100e becomes the predetermined distance Dp, the same process as that at the time of the situation shown in FIG. 4 is performed.

Furthermore, the action planning unit 66 plans a notification action to notify the vehicle occupant that the hearse 100h and the like are traveling, and that the vehicle control will be carried out accompanying the approach of the hearse 100h and the like. The notification control unit 70 outputs a notification instruction to the notification device 86 corresponding to the notification action planned by the action planning unit 66.

In step S4, the external environment recognition unit 62 monitors the region in front of the host vehicle 10. Based on the image information or the external environmental information, the external environment recognition unit 62 recognizes the other vehicles 100 that exist in the monitoring direction, and from among the other vehicles 100, identifies the hearse 100h and the like.

If the external environment recognition unit 62 is incapable of identifying the hearse 100h and the like (step S5: NO), it is indicative of a state in which the hearse 100h and the like are located away from the planned route of the host vehicle 10 or the host vehicle travel path 120. At this time, the external environment recognition unit 62 recognizes that the hearse 100h and the like are not present in the frontward direction, and the process proceeds to step S6. On the other hand, in the case that the external environment recognition unit 62 identifies the hearse 100h and the like (step S5: YES), it is indicative of a state in which the hearse 100h and the like are traveling on the planned route of the host vehicle 10 or the host vehicle travel path 120. At this time, the process returns to step S4, and the external environment recognition unit 62 continues to perform monitoring of the region in front of the host vehicle 10.

Transitioning from step S5 to step S6, the action planning unit 66 plans an action to restart normal traveling. The vehicle control unit 68 calculates a steering amount and a degree of acceleration of the host vehicle 10 on the basis of the action planned by the action planning unit 66, outputs a steering instruction to the steering device 82, and outputs an acceleration instruction to the driving force output device 80.

[3. Method of Identifying Hearse 100h and Funeral Attendant Vehicle 100a]

Examples will be described of identification methods which are performed by the external environment recognition unit 62 for identifying the hearse 100h and the funeral attendant vehicle 100a. It is possible to identify the hearse 100h by any one of the methods (1) to (3) described below. It is also possible to combine at least one of the methods (1) to (3) and at least one of the methods (4) and (5). In this case, in methods (1) to (3), other vehicles 100 for which there is a high possibility of them being a hearse 100h are specified, and in methods (4) and (5), it is possible to determine whether or not from among such other vehicles 100, the other vehicle 100 is the hearse 100h. In the case that scores are assigned to the identification results by each of the methods, and if the score is greater than or equal to a predetermined threshold value, it is possible to identify a target other vehicle 100 as the hearse 100h or the funeral attendant vehicle 100a. Of course, other identification methods may be added thereto when the other vehicles 100 are identified. Combining of the methods (1) to (5) and other identification methods increases the accuracy of the identification. The same can be said with respect to the identification method [3.6] of the funeral attendant vehicle 100a.

[3.1. Identification Method (1) of Hearse 100h]

In the case that, on the basis of the image information, the external environment recognition unit 62 recognizes a characteristic of an external appearance of the hearse 100h on another vehicle 100, the external environment recognition unit 62 can identify the other vehicle 100 that possesses such a characteristic as the hearse 100h. For example, the other vehicle 100 is identified as the hearse 100h in the case it is recognized that the color of the vehicle body is black, that the height of the vehicle is greater than a predetermined vehicle height, that the appearance and shape are of a shape peculiar to a hearse, that the vehicle body is decorated with decorations peculiar to a hearse, that a peculiar marking is affixed to the vehicle body, that flags exist on the front of the vehicle body or on an upper portion of the front wheels, that a hazard lamp is illuminated, or the like. At this time, a technique such as template matching or the like can be utilized.

[3.2. Identification Method (2) of Hearse 100h]

In the case that the external environmental information received by the first communication device 34 includes information indicative of it being a hearse 100h, the external environment recognition unit 62 can identify the other vehicle 100 as the hearse 100h. Within the external environmental information, there may be included information indicating that the other vehicle 100 itself is a hearse 100h, and information indicating that the hearse 100h possesses an external appearance characteristic as described in item [3.1] above.

[3.3. Identification Method (3) of Hearse 100h]

In the case that, on the basis of the image information and the external environmental information, the external environment recognition unit 62 identifies a police vehicle 100p (see FIG. 4) from among the other vehicles 100, and recognizes another vehicle 100 following the police vehicle 100p, the external environment recognition unit 62 can identify the other vehicle 100 as the hearse 100h. For example, on the condition that the vehicle velocity of another vehicle 100 is less than or equal to a threshold value, then in the case it is recognized that the other vehicle 100 is two or more motorcycles traveling in parallel, or if a characteristic of a police vehicle 100p such as having a rotating lamp or the like is recognized, the other vehicle 100 is identified as being a police vehicle 100p. In addition, the other vehicle 100, which is following the police vehicle 100p while maintaining a constant inter-vehicle distance, is identified as the hearse 100h.

[3.4. Identification Method (4) of Hearse 100h]

In the case that, on the basis of the image information, the external environment recognition unit 62 recognizes a group of people 140 lined up along the roadside (see FIG. 4), the external environment recognition unit 62 can determine that there is a possibility that a hearse 100h may be present. In addition, in the case that, by way of a different identification method, another vehicle 100 is recognized for which there is a possibility of it being a hearse 100h, the other vehicle 100 is recognized as the hearse 100h. For example, the external environment recognition unit 62 recognizes the group of people 140 in the case that persons of a predetermined number of people or greater are lined up along the roadside, and furthermore, the density or clustering together of such people is greater than or equal to a threshold value.

[3.5. Identification Method (5) of Hearse 100h]

The external environment recognition unit 62 is capable of acquiring information as to whether or not a cemetery exists within a predetermined distance from the position of the host vehicle 10, based on the external environmental information or the map information 48 acquired by the second communication device 36 (or the high precision map of the map unit 40). In addition, in the case that such a cemetery exists, and by way of a different identification method another vehicle 100 is recognized for which there is a possibility of it being a hearse 100h, the other vehicle 100 is recognized as the hearse 100h.

[3.6. Method of Identifying Funeral Attendant Vehicle 100a]

In the case that another vehicle 100 that satisfies a predetermined condition is recognized, the external environment recognition unit 62 can identify the other vehicle 100 as a funeral attendant vehicle 100a. For example, in the same manner as in the aforementioned item [3.1], in the case that the external environment recognition unit 62 recognizes a characteristic of an external appearance of the funeral attendant vehicle 100a, the external environment recognition unit 62 identifies the other vehicle 100 that possesses such a characteristic as the funeral attendant vehicle 100a. For example, in the case it is recognized that a peculiar marking is affixed to the vehicle body, or that a hazard lamp is illuminated, or the like, the other vehicle 100 is identified as the funeral attendant vehicle 100a. Further, in the same manner as in the aforementioned item [3.2], in the case that information is included within the external environmental information indicating that the vehicle itself is a funeral attendant vehicle 100a, the external environment recognition unit 62 identifies the other vehicle 100 as the funeral attendant vehicle 100a.

### [3.7. Other Identification Methods]

Other methods may be considered for identifying the hearse 100h and the funeral attendant vehicle 100a. For example, normally, the hearse 100h and the funeral attendant vehicle 100a travel at a low velocity. Thus, the vehicle velocities of the other vehicles 100 may be detected, and it may be recognized that a possibility exists that the other vehicles 100, which travel at a predetermined vehicle velocity or less, are the hearse 100h or the funeral attendant vehicle 100a. Also, the hearse 100h may sound a car horn. Thus, surrounding sounds may be collected by a microphone, and it may be recognized that a possibility exists that the other vehicles 100, which are sounding a car horn, are the hearse 100h or the funeral attendant vehicle 100a.

### [4. Modifications]

### [4.1. Modification (1)]

In the embodiment described above, in the situation shown in FIG. 5, the vehicle control device 18 causes the host vehicle 10 to travel in a manner so that the distance D between the trailing end vehicle 100e and the host vehicle 10 is kept constant after having positioned the host vehicle 10 behind the trailing end vehicle 100e of the hearse 100h and the like. Instead of this feature, the vehicle control device 18 may position the host vehicle 10 behind the trailing end vehicle 100e of the hearse 100h and the like, and thereafter, may cause the host vehicle 10 to move to an edge of the host vehicle travel path 120 and come to a stop.

In this case, the action planning unit 66 assumes a center line 126 that passes through the center in the vehicle widthwise direction of the hearse 100h and the like, and extends in the direction in which a travel lane 124 extends. In addition, a travel trajectory is generated by which the host vehicle 10 is made to move in a direction away from the center line 126 until reaching the edge of the host vehicle travel path 120. Furthermore, the action planning unit 66 plans an action of gradually decelerating the host vehicle 10, and finally causing the host vehicle 10 to stop at the edge of the host vehicle travel path 120. The vehicle control unit 68 calculates a steering amount and a degree of deceleration of the host vehicle 10 on the basis of the action planned by the action planning unit 66, outputs a steering instruction to the steering device 82, and outputs a deceleration/stopping instruction to the braking device 84.

When the vehicle occupant operates the restart switch 54 after the host vehicle 10 has stopped, then on the basis of the image information or the external environmental information, the external environment recognition unit 62 recognizes the presence or absence of the hearse 100h and the like within a predetermined range in front of the host vehicle 10. In the case that the hearse 100h and the like are not present, the action planning unit 66 generates a travel trajectory for causing the host vehicle 10 to move into the nearest travel lane 124. The vehicle control unit 68 calculates a steering amount and a degree of acceleration of the host vehicle 10 on the basis of the action planned by the action planning unit 66, outputs a steering instruction to the steering device 82, and outputs an acceleration instruction to the driving force output device 80.

### [4.2. Modification (2)]

According to Modification (1), the vehicle control device 18 positions the host vehicle 10 behind the trailing end vehicle 100e of the hearse 100h and the like, and thereafter, causes the host vehicle 10 to move to the edge of the host vehicle travel path 120 and come to a stop. Instead of this feature, the vehicle control device 18 may cause the host vehicle 10 to move to an edge of the host vehicle travel path 120 and come to a stop prior to positioning the host vehicle 10 behind the trailing end vehicle 100e of the hearse 100h and the like. In this case, after the host vehicle 10 has stopped, the action planning unit 66 keeps the vehicle stopped until the hearse 100h and the like have passed alongside the host vehicle 10. As a result, the vehicle control device 18 causes the host vehicle 10 to be positioned rearwardly of the trailing end vehicle 100e of the hearse 100h and the like.

### [4.3. Modification (3)]

In Modification (1) and Modification (2), the vehicle occupant operates the restart switch 54, whereby traveling of the host vehicle 10 is restarted. Instead of this feature, traveling of the host vehicle 10 may be restarted automatically. In this case, at a point in time when the external environment recognition unit 62 no longer recognizes the hearse 100h and the like within a predetermined range, or after a predetermined time period has elapsed from such a point in time, the action planning unit 66 generates a travel trajectory for causing the host vehicle 10 to move into the nearest travel lane 124. The vehicle control unit 68 calculates a steering amount and a degree of acceleration of the host vehicle 10 on the basis of the action planned by the action planning unit 66, outputs a steering instruction to the steering device 82, and outputs an acceleration instruction to the driving force output device 80.

### [4.4. Modification (4)]

In the case that the external environment recognition unit 62 is incapable of clearly identifying whether or not the other vehicle 100 is the hearse 100h or the funeral attendant vehicle 100a, control of the vehicle may be entrusted to the vehicle occupant. In this case, the action planning unit 66 plans a notification action to prompt the vehicle occupant to select a vehicle control. The notification control unit 70 outputs a notification instruction to the notification device 86 corresponding to the notification action planned by the action planning unit 66. For example, the vehicle occupant may select whether or not to continue with automated driving, or may select an action to avoid the hearse 100h or the funeral attendant vehicle 100a.

### [4.5. Modification (5)]

In Modification (1) and Modification (2), when the host vehicle 10 restarts traveling, there is a possibility that the host vehicle 10 may catch up with the hearse 100h and the funeral attendant vehicle 100a. The planned route may be reset in a manner so that the host vehicle 10 cannot catch up with the hearse 100h and the funeral attendant vehicle 100a.

In this case, the action planning unit 66 issues an instruction with respect to the navigation device 42 to reset the planned route. The route setting unit 46 sets a new planned route in which the road on which the hearse 100h and the funeral attendant vehicle 100a are traveling at that point in time is excluded. If there is a cemetery that exists in the vicinity, a route from the position of the hearse 100h to the cemetery may be predicted, and a new planned route may be set that avoids such a predicted route.

### [5. Summary of the Embodiment]

The vehicle control device 18 according to the present embodiment is equipped with the external environment recognition unit 62 configured to recognize the environment around the periphery of the host vehicle 10, the action planning unit 66 configured to plan an action of the host vehicle 10 on the basis of the recognition result of the external environment recognition unit 62, and the vehicle control unit 68 configured to cause the host vehicle 10 to travel in accordance with the action planned by the action planning unit 66. The external environment recognition unit 62 is configured to identify the hearse 100h or the funeral attendant vehicle 100a following the hearse 100h, from among at least one other vehicle 100 traveling in a same forward traveling direction as the host vehicle 10 in front of or on a side of the host vehicle 10. In the case that the external environment recognition unit 62 identifies the hearse 100h or the funeral attendant vehicle 100a, the action planning unit 66 is configured to plan an action of positioning the host vehicle 10 at a location more rearwardly than a vehicle at a trailing end (trailing end vehicle 100e) from among the hearse 100h and the funeral attendant vehicle 100a.

In accordance with the above-described configuration, by positioning the host vehicle 10 rearwardly of the trailing end vehicle 100e from among the hearse 100h and the funeral attendant vehicle 100a, the hearse 100h and the funeral attendant vehicle 100a are allowed to travel in a more preferential manner than the host vehicle 10, and therefore, it is possible to enable the hearse 100h and the funeral attendant vehicle 100a to travel smoothly. Further, the host vehicle 10 can be made to move in a customary way.

The action planning unit 66 may be configured to plan an action to cause the host vehicle 10 to decelerate when the vehicle velocity V of the host vehicle 10 is higher than the vehicle velocity Ve of the hearse 100h and the funeral attendant vehicle 100a.

In accordance with the above-described configuration, the host vehicle 10 does not pass or overtake the hearse 100h or the funeral attendant vehicle 100a, and therefore, the hearse 100h can be allowed to travel smoothly.

At a rearward position of the hearse 100h or the funeral attendant vehicle 100a, the action planning unit 66 may be configured to plan an action to maintain a constant distance D between the host vehicle 10 and the vehicle at the trailing end (trailing end vehicle 100e) from among the hearse 100h and the funeral attendant vehicle 100a.

In accordance with the above-described configuration, the host vehicle 10 does not pass or overtake the hearse 100h or the funeral attendant vehicle 100a, and therefore, the hearse 100h can be allowed to travel smoothly.

The action planning unit 66 is configured to plan an action to cause the host vehicle 10 to move to an edge of the host vehicle travel path 120 and come to a stop, when a vehicle velocity V of the host vehicle 10 is higher than the vehicle velocity Ve of the hearse 100h and the funeral attendant vehicle 100a.

In accordance with the above-described configuration, the host vehicle 10 does not pass or overtake the hearse 100h or the funeral attendant vehicle 100a, and therefore, the hearse 100h can be allowed to travel smoothly.

The vehicle control device 18 according to the present embodiment further comprises at least one of the camera 22 configured to capture images of the periphery of the host vehicle 10 and acquire image information, and the communication device 32 configured to receive the external environmental information transmitted from the external environment, wherein the external environment recognition unit 62 is configured to recognize the other vehicle 100 based on the image information or the external environmental information.

In accordance with the above-described configuration, it is possible to recognize the hearse 100h using the image captured by the cameras 22 or information transmitted from the other vehicle 100.

In the case that the external environment recognition unit 62 recognizes a characteristic of an external appearance of the hearse 100h on the other vehicle 100, the external environment recognition unit 62 is configured to identify the other vehicle 100 that possesses the characteristic as the hearse 100h.

In accordance with the above-described configuration, it is possible to recognize the hearse 100h from a characteristic feature of the hearse 100h, for example, from an appearance and shape, a color, a decoration, a marking, a lighting state of a hazard light, a flag, etc., of the hearse 100h.

In the case that the external environment recognition unit 62 identifies a police vehicle 100p from among the other vehicle 100, and recognizes another vehicle 100 following the police vehicle 100p, the external environment recognition unit 62 is configured to identify the other vehicle 100 as the hearse 100h.

In accordance with the above-described configuration, it is possible to recognize the hearse 100h from a travel state that is peculiar to a hearse 100h, in this instance, a motorcade with a police vehicle 100p at a leading end thereof.

In the case that the external environment recognition unit 62 recognizes a group of people 140 lined up along a roadside, and the other vehicle 100 exists for which there is a possibility of it being the hearse 100h, the external environment recognition unit 62 is configured to identify the other vehicle 100 as the hearse 100h.

In accordance with the above-described configuration, it is possible to recognize the existence of the hearse 100h from a surrounding environment that is peculiar to a time of traveling of the hearse 100h, in this instance, the existence of the group of people 140 lined up along the roadside.

The vehicle control device 18 according to the present embodiment is equipped with the positioning unit 44 configured to measure the position of the host vehicle 10. The external environment recognition unit 62 is configured to acquire information as to whether or not a cemetery exists within a predetermined distance from the position of the host vehicle 10 based on the external environmental information or the map information 48, and in the case that the cemetery exists, and the other vehicle 100 exists for which there is a possibility of it being the hearse 100h, the external environment recognition unit is configured to identify the other vehicle 100 as the hearse 100h.

In accordance with the above-described configuration, it is possible to recognize the existence of the hearse 100h from a surrounding environment that is peculiar to a time of traveling of the hearse 100h, in this instance, the existence of a cemetery.

In the case that the external environment recognition unit 62 recognizes a characteristic of an external appearance of the funeral attendant vehicle 100a on the other vehicle 100, the external environment recognition unit 62 is configured to identify the other vehicle 100 that possesses the characteristic as the funeral attendant vehicle 100a.

In accordance with the above-described configuration, it is possible to recognize the funeral attendant vehicle 100a based on a characteristic feature of the funeral attendant vehicle 100a, for example, a marking, a lighting state of a hazard light, and the like.

The vehicle control device 18 according to the present embodiment is equipped with the notification control unit 70 configured to control notification to the vehicle occupant according to a notification action planned by the action planning unit 66. In the case that the external environment recognition unit 62 is incapable of identifying whether or not the other vehicle 100 is the hearse 100h, the action planning unit 66 is configured to plan the notification action to prompt the vehicle occupant to select a vehicle control.

In accordance with the above-described configuration, since the driver selects the control in the event it is impossible to recognize on the side of the vehicle whether or not the other vehicle 100 is a hearse 100h, in the case that the other vehicle 100 is a hearse 100h, the driver can appropriately determine the control, and as a result, it is possible to enable the hearse 100h to travel smoothly.

Further, in the case that the external environment recognition unit 62 is incapable of identifying whether or not the other vehicle 100 is the funeral attendant vehicle 100a, the action planning unit 66 is configured to plan the notification action to prompt the vehicle occupant to select a vehicle control.

In accordance with the above-described configuration, since the driver selects the control in the event it is impossible to recognize on the side of the vehicle whether or not the other vehicle 100 is a funeral attendant vehicle 100a, in the case that the other vehicle 100 is a funeral attendant vehicle 100a, the driver can appropriately determine the control, and as a result, it is possible to enable the funeral attendant vehicle 100a to travel smoothly.

After the host vehicle 10 has stopped, the external environment recognition unit 62 is configured to recognize whether or not the hearse 100h or the funeral attendant vehicle 100a exists within a predetermined range in front of the host vehicle 10. In the case that the external environment recognition unit 62 recognizes that the hearse 100h and the funeral attendant vehicle 100a do not exist within the predetermined range, the action planning unit 66 is configured to plan an action to restart traveling of the host vehicle 10.

In accordance with the above-described configuration, it is possible to promptly restart normal traveling of the host vehicle 10.

The vehicle control device 18 according to the present embodiment is further equipped with the restart switch 54 configured to output a travel restart signal in response to an operation of the vehicle occupant. After the host vehicle 10 has stopped, the external environment recognition unit 62 is configured to recognize whether or not the hearse 100h or the funeral attendant vehicle 100a exists within a predetermined range in front of the host vehicle 10. In the case that the external environment recognition unit 62 recognizes that the hearse 100h and the funeral attendant vehicle 100a do not exist within the predetermined range, and detects the travel restart signal, the action planning unit 66 is configured to plan an action to restart traveling of the host vehicle 10.

In accordance with the above-described configuration, it is possible to restart normal traveling of the host vehicle 10 at a desired timing.

In the case that the external environment recognition unit 62 identifies the hearse 100h and the funeral attendant vehicle 100a, the action planning unit 66 is configured to plan the notification action to notify the vehicle occupant that the hearse 100h and the funeral attendant vehicle 100a are traveling.

In accordance with the above-described configuration, it is possible to cause the vehicle occupant to recognize the existence of the hearse 100h, and further, it is possible to grasp the cause of a behavior of the host vehicle 10 (movement, deceleration, etc., of the host vehicle 10).

In addition to the positioning unit 44, the vehicle control device 18 according to the present embodiment comprises the route setting unit 46 configured to set a planned route from the position of the host vehicle 10 to a destination on the basis of the map information 48. In the case that the action planning unit 66 plans an action to cause the host vehicle 10 to travel along the planned route, and the external environment recognition unit 62 identifies the hearse 100h and the funeral attendant vehicle 100a, the action planning unit 66 is configured to instruct the route setting unit 46 to reset the planned route. In accordance with the instruction from the action planning unit 66, the route setting unit 46 is configured to reset a new planned route to avoid a road on which the hearse 100h and the funeral attendant vehicle 100a travel.

In accordance with the above-described configuration, it is possible to avoid encountering the hearse 100h again after the host vehicle 10 has restarted normal traveling.

The vehicle control device according to the present invention is not limited to the embodiment discussed above, and it goes without saying that various additional or alternative configurations could be adopted therein without departing from the essence and gist of the present invention.

What is claimed is:

1. A vehicle control device, comprising:
an external environment recognition unit configured to recognize an environment around a periphery of a host vehicle;
an action planning unit configured to plan an action of the host vehicle on a basis of a recognition result of the external environment recognition unit; and
a vehicle control unit configured to cause the host vehicle to travel in accordance with the action planned by the action planning unit;
wherein the external environment recognition unit is configured to identify a hearse or a funeral attendant vehicle following the hearse, from among at least one other vehicle traveling in a same forward traveling direction as the host vehicle in front of or on a side of the host vehicle; and
in a case that the external environment recognition unit identifies the hearse or the funeral attendant vehicle, the action planning unit is configured to plan an action of positioning the host vehicle at a location more rearwardly than a vehicle at a trailing end from among the hearse and the funeral attendant vehicle.

2. The vehicle control device according to claim 1, wherein the action planning unit is configured to plan an action to cause the host vehicle to decelerate when a vehicle velocity of the host vehicle is higher than the vehicle velocity of the hearse and the funeral attendant vehicle.

3. The vehicle control device according to claim 1, wherein, at a rearward position of the hearse or the funeral attendant vehicle, the action planning unit is configured to plan an action to maintain a constant distance between the host vehicle and the vehicle at the trailing end from among the hearse and the funeral attendant vehicle.

4. The vehicle control device according to claim 1, wherein the action planning unit is configured to plan an action to cause the host vehicle to move to an edge of the travel path and come to a stop, when a vehicle velocity of the host vehicle is higher than the vehicle velocity of the hearse and the funeral attendant vehicle.

5. The vehicle control device according to claim 1, further comprising at least one of:
a camera configured to capture an image of the periphery of the host vehicle and acquire image information; and
a communication device configured to receive external environmental information transmitted from the external environment;
wherein the external environment recognition unit is configured to recognize the other vehicle based on the image information or the external environmental information.

6. The vehicle control device according to claim 5, wherein, in a case that the external environment recognition unit recognizes a characteristic of an external appearance of the hearse on the other vehicle, the external environment recognition unit is configured to identify the other vehicle that possesses the characteristic as the hearse.

7. The vehicle control device according to claim 5, wherein, in a case that the external environment recognition unit identifies a police vehicle from among the other vehicle, and recognizes another vehicle following the police vehicle, the external environment recognition unit is configured to identify the other vehicle as the hearse.

8. The vehicle control device according to claim 5, wherein, in a case that the external environment recognition unit recognizes a group of people lined up along a roadside, and the other vehicle exists for which there is a possibility of it being the hearse, the external environment recognition unit is configured to identify the other vehicle as the hearse.

9. The vehicle control device according to claim 5, further comprising:
a positioning unit configured to measure a position of the host vehicle;
wherein the external environment recognition unit is configured to acquire information as to whether or not a cemetery exists within a predetermined distance from the position of the host vehicle based on the external environmental information or map information, and in a case that the cemetery exists, and the other vehicle exists for which there is a possibility of it being the hearse, the external environment recognition unit is configured to identify the other vehicle as the hearse.

10. The vehicle control device according to claim 1, wherein, in a case that the external environment recognition unit recognizes a characteristic of an external appearance of the funeral attendant vehicle on the other vehicle, the external environment recognition unit is configured to identify the other vehicle that possesses the characteristic as the funeral attendant vehicle.

11. The vehicle control device according to claim 1, further comprising:
a notification control unit configured to control notification to a vehicle occupant according to a notification action planned by the action planning unit;
wherein, in a case that the external environment recognition unit is incapable of identifying whether or not the other vehicle is the hearse, the action planning unit is configured to plan the notification action to prompt the vehicle occupant to select a vehicle control.

12. The vehicle control device according to claim 1, further comprising:
a notification control unit configured to control notification to a vehicle occupant according to a notification action planned by the action planning unit;
wherein, in a case that the external environment recognition unit is incapable of identifying whether or not the other vehicle is the funeral attendant vehicle, the action planning unit is configured to plan the notification action to prompt the vehicle occupant to select a vehicle control.

13. The vehicle control device according to claim 4, wherein after the host vehicle has stopped,
the external environment recognition unit is configured to recognize whether or not the hearse or the funeral attendant vehicle exists within a predetermined range in front of the host vehicle; and
in a case that the external environment recognition unit recognizes that the hearse and the funeral attendant vehicle do not exist within the predetermined range, the action planning unit is configured to plan an action to restart traveling of the host vehicle.

14. The vehicle control device according to claim 4, further comprising:
a restart switch configured to output a travel restart signal in response to an operation of the vehicle occupant;
wherein after the host vehicle has stopped,
the external environment recognition unit is configured to recognize whether or not the hearse or the funeral attendant vehicle exists within a predetermined range in front of the host vehicle; and
in a case that the external environment recognition unit recognizes that the hearse and the funeral attendant vehicle do not exist within the predetermined range, and detects the travel restart signal, the action planning unit is configured to plan an action to restart traveling of the host vehicle.

15. The vehicle control device according to claim 1, further comprising:
a notification control unit configured to control notification to a vehicle occupant according to a notification action planned by the action planning unit;
wherein, in a case that the external environment recognition unit identifies the hearse and the funeral attendant vehicle, the action planning unit is configured to plan the notification action to notify the vehicle occupant that the hearse and the funeral attendant vehicle are traveling.

16. The vehicle control device according to claim 1, further comprising:
a positioning unit configured to measure a position of the host vehicle; and
a route setting unit configured to set a planned route from a position of the host vehicle to a destination on a basis of map information;
wherein, in a case that the action planning unit plans an action to cause the host vehicle to travel along the planned route, and the external environment recognition unit identifies the hearse and the funeral attendant vehicle, the action planning unit is configured to instruct the route setting unit to reset the planned route; and
according to the instruction from the action planning unit, the route setting unit is configured to reset a new planned route to avoid a road on which the hearse and the funeral attendant vehicle travel.
